(19) United States
(12) Patent Application Publication
(10) Pub. No.: US 2023/0137916 A1
(43) Pub. Date: May 4, 2023

(54) DISPLAY DEVICE AND DISPLAY METHOD

(71) Applicant: Panasonic Intellectual Property Management Co., Ltd., Osaka (JP)

(72) Inventors: Hiroyuki KADO, Osaka (JP); Hiroshi MITANI, Osaka (JP)

(21) Appl. No.: 18/089,840

(22) Filed: Dec. 28, 2022

Related U.S. Application Data
(63) Continuation of application No. PCT/JP2021/008229, filed on Mar. 3, 2021.

(30) Foreign Application Priority Data
Jul. 6, 2020 (JP) 2020-116580

(51) Int. Cl. G02F 1/1347; G09G 3/36

(52) U.S. Cl. CPC G02F 1/1347; G09G 3/36; G09G 2310/0264

(57) ABSTRACT

A display device can display a display image obtained by superimposing a plurality of sub display images, and includes n number of liquid crystal displays, where n is an integer of 2 or more, that display the plurality of sub display images, a light source that is provided for each liquid crystal display and is capable of emitting light of m number of different colors, where m is an integer of 2 or more, and a processor that causes the light source corresponding to the liquid crystal display to emit light of a different color based on an input signal including color information on the display image displayed by each liquid crystal display. The number n of the liquid crystal display is an integral multiple of the number m of color of light that the light source is capable of emitting.

### CROSS-REFERENCE TO RELATED APPLICATIONS

This is a continuation of International Application No. PCT/JP2021/008229 filed on Mar. 3, 2021, and claims priority from Japanese Patent Application No. 2020-116580 filed on Jul. 6, 2020, the entire content of which is incorporated herein by reference.

### TECHNICAL FIELD

The present disclosure relates to a display device and a display method.

### BACKGROUND ART

Patent Literature 1 discloses a field sequential liquid crystal display device. The field sequential liquid crystal display device includes a liquid crystal panel and a backlight including a plurality of light emitting elements that emit light of different colors. In a liquid crystal display device, a plurality of light emitting elements of colors corresponding to respective fields are turned on in a plurality of field periods of each frame period, and a subfield period in which a plurality of light emitting elements corresponding to colors other than those of the turned-on light emitting elements are sequentially turned on is provided at least once in at least one field period of the plurality of field periods.

### CITATION LIST

### Patent Literature

Patent Literature 1: JP2008-20758A

### SUMMARY OF INVENTION

The present disclosure has been proposed in view of the above circumstances, and an object thereof is to provide a display device and a display method capable of preventing color breakup of a display image displayed by using a field sequential color system.

The present disclosure provides a display device capable of displaying a display image obtained by superimposing a plurality of sub display images. The display device includes n number of liquid crystal displays (n is an integer equal to or greater than 2) that display the plurality of sub display images, a light source that is provided for each liquid crystal display and is capable of emitting light of m number of different colors (m is an integer equal to or greater than 2), and a processor that causes the light source corresponding to the liquid crystal display to emit light of a different color based on an input signal including color information on the display image displayed by each liquid crystal display. The number n of the liquid crystal display is an integral multiple of the number m of color of light that the light source is capable of emitting.

Further, the present disclosure provides a display method capable of displaying a display image obtained by superimposing a plurality of sub display images, the display method including: acquiring an input signal including color information of the sub display images to be displayed individually by n number of liquid crystal displays (n is an integer equal to or greater than 2); and causing a light source, which is provided for each liquid crystal display and is capable of emitting light of m number of different colors (m is an integer equal to or greater than 2), to emit light of different colors based on the color information. The number n of the liquid crystal display is an integral multiple of the number m of color of light that the light source is capable of emitting.

According to the present disclosure, it is possible to prevent color breakup of a display image displayed using a field sequential color system.

### BRIEF DESCRIPTION OF DRAWINGS

FIG. 1 is a diagram illustrating a structure example of a main part of a display device according to an embodiment.

FIG. 2 is a diagram illustrating a first arrangement example of a light source according to the embodiment.

FIG. 3 is a diagram illustrating a second arrangement example of the light source according to the embodiment.

FIG. 4 is a diagram illustrating a third drive control example of the display device.

### DESCRIPTION OF EMBODIMENTS

### (Background of the Present Disclosure)

Patent Literature 1 discloses a liquid crystal display device using a field sequential color (FSC) system. In the liquid crystal display device, a red LED, a green LED, and a blue LED are arranged on a rear surface of a liquid crystal panel, and an achromatic color (white or gray) field for simultaneously turning on the red LED, the green LED, and the blue LED in each of a plurality of field periods obtained by dividing one frame is provided, thereby further preventing color breakup of a display image.

However, in the liquid crystal display device, even if an achromatic color (white or gray) is superimposed on a single color (red, green, or blue), the effect of reducing color breakup may be poor. In addition, in order to cause the LED of another color to emit light in a field period in which a display image of a corresponding color is written, there is a problem that the color purity is reduced.

The color breakup occurs when, in a display image in which LEDs of a plurality of colors are sequentially turned on in a field sequential color system, it is displayed that a viewer's point of view or a liquid crystal display is moving. The color breakup is a phenomenon in which a display image (color) visually recognized by a viewer is remained as an afterimage, and a display image (color) displayed before can be seen separately when a next different display image (color) is displayed. The color breakup can be reduced by increasing a refresh rate of a liquid crystal display. However, due to a limit in reduction of a respond time of liquid crystal, there is a limit in increase of the refresh rate.

Therefore, in the following embodiment, an example of a display device and a display method capable of preventing color breakup of a display image by using a plurality of liquid crystal displays using a field sequential color system will be described.

Hereinafter, an embodiment specifically disclosing configurations and operations of a display device and a display method according to the present disclosure will be described in detail with reference to the drawings as appropriate. An unnecessarily detailed description may be omitted. For example, a detailed description of well-known matters and a repeated description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matters described in the claims.

In addition, a display image displayed by the display device according to the present embodiment will be described. The display device allows a viewer to see one single display image obtained by superimposing display images (hereinafter, referred to as “sub display images”) displayed by a plurality of liquid crystal displays respectively. Accordingly, the viewer can visually recognize the display image as a stereoscopic image. However, in the display device, for example, in a case where the same sub display images are displayed on a plurality of liquid crystal displays respectively, a display image obtained after superimposing the sub display images may not be a stereoscopic image. Therefore, the display device according to the present embodiment described below is not limited to a configuration and an operation of displaying a stereoscopic image, and is not excluded to have a configuration and an operation of displaying a display image that is not a stereoscopic image.

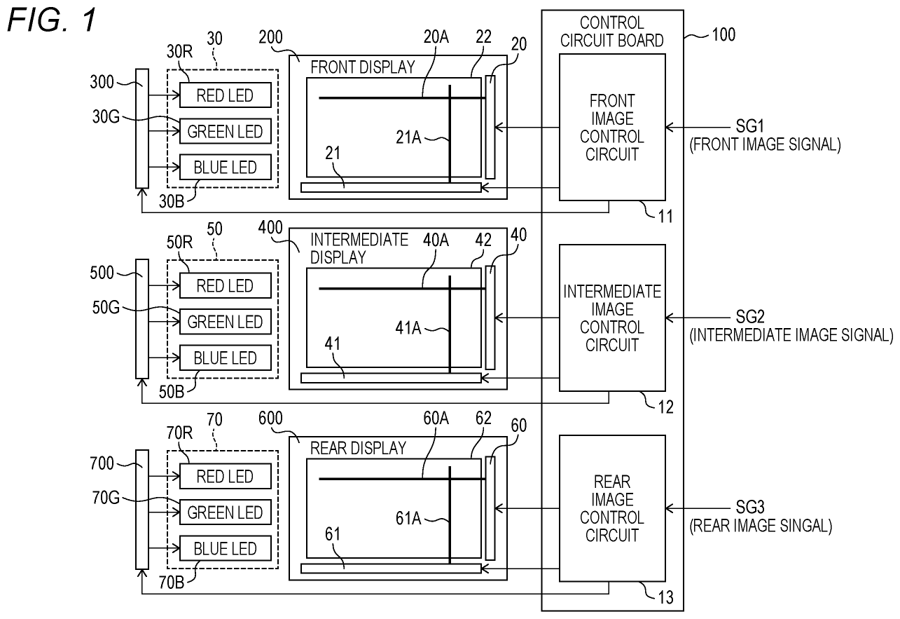

A structure of the display device according to the embodiment will be described with reference to FIG. 1. FIG. 1 is a diagram illustrating a structure example of a main part of the display device according to the embodiment. The display device according to the embodiment includes a plurality of liquid crystal displays, displays sub display images on the plurality of liquid crystal displays respectively, and allows a viewer to see a display image (stereoscopic image) obtained by superimposing the sub display images.

Also, although an example is shown in which LEDs of three colors (a red LED, a green LED, and a blue LED) are provided as a light source in the display device illustrated in FIG. 1, the number of colors of the light source is not limited to three, and may be, for example, two or four or more. Further, although an example is shown in which three liquid crystal displays (liquid crystal panels) are provided in the display device illustrated in FIG. 1, the number of liquid crystal displays (liquid crystal panels) is an integral multiple of the number of colors of the light source provided in the liquid crystal display. That is, when the number of colors of the light source is two, the number of liquid crystal displays may be an integral multiple of two, and when the number of colors of the light source is four, the number of liquid crystal displays may be an integral multiple of four.

The display device includes a control circuit board 100, a front display 200, an intermediate display 400, a rear display 600, LED drive circuits 300, 500, and 700, and light sources 30, 50 and 70. A liquid crystal drive system for each of the plurality of liquid crystal displays provided in the display device according to the embodiment is an FSC system.

The control circuit board 100 as an example of a processor is configured by using, for example, a central processing unit (CPU) or a field programmable gate array (FPGA), and performs various types of processing and control in cooperation with a memory (not illustrated). Specifically, the control circuit board 100 refers to a program and data stored in the memory and executes the program, thereby implementing a function of controlling a sub display image displayed on the front display 200 based on a front image signal SG1, control of a sub display image displayed on the intermediate display 400 based on an intermediate image signal SG2, and a function of controlling a sub display image displayed on the rear display 600 based on a rear image signal SG3.

Here, the image signals as an example of an input signal will be described. The front image signal SG1 is a signal for displaying a sub display image on the front display 200, and includes at least color information and luminance information to be displayed on each of all the pixels provided in the front display 200. The intermediate image signal SG2 is a signal for displaying a sub display image on the intermediate display 400, and includes at least color information and luminance information to be displayed on each of all the pixels provided in the intermediate display 400. The rear image signal SG3 is a signal for displaying a sub display image on the rear display 600, and includes at least color information and luminance information to be displayed on each of all the pixels provided in the rear display 600.

The control circuit board 100 receives inputs of the front image signal SG1, the intermediate image signal SG2, and the rear image signal SG3. The control circuit board 100 generates, based on the input front image signal SG1, a control signal for controlling a sub display image displayed on the front display 200, and outputs the control signal to a scanning line drive circuit 20, a video line drive circuit 21, and the LED drive circuit 300. The control circuit board 100 generates, based on the input intermediate image signal SG2, a control signal for controlling a sub display image displayed on the intermediate display 400, and outputs the control signal to a scanning line drive circuit 40, a video line drive circuit 41, and the LED drive circuit 500. The control circuit board 100 generates, based on the input rear image signal SG3, a control signal for controlling the sub display image displayed on the rear display 600, and outputs the control signal to a scanning line drive circuit 60, a video line drive circuit 61, and the LED drive circuit 700. The control circuit board 100 includes a front image control circuit 11, an intermediate image control circuit 12, and a rear image control circuit 13.

Based on the input front image signal SG1, the front image control circuit 11 generates control signals for controlling the scanning line drive circuit 20, the video line drive circuit 21, and the LED drive circuit 300 (hereinafter referred to as “front-side drive circuits”) respectively.

Based on the luminance information included in the front image signal SG1, the front image control circuit 11 generates a control signal for controlling scanning lines 20A provided on a front panel 22 and a control signal for controlling video lines 21A provided on the front panel 22. Based on the color information included in the front image signal SG1, the front image control circuit 11 generates a control signal for driving the LED drive circuit 300. Each of the control signals generated by the front image control circuit 11 includes a timing signal (that is, a synchronization signal) by which the scanning line drive circuits 20, the video line drive circuits 21, and the LED drive circuits 300 can be driven in synchronization with each other. The front image control circuit 11 outputs the generated control signals to the front-side drive circuits.

The control signal for controlling the scanning lines 20A is generated including information on a voltage value to be applied to the scanning lines 20A. The control signal for controlling the video lines 21A is generated including information on a voltage value to be applied to the video lines 21A. The control signal for driving the LED drive circuit 300 is generated including information on LEDs to be turned on.

Based on the input intermediate image signal SG2, the intermediate image control circuit 12 generates control signals for controlling the scanning line drive circuit 40, the video line drive circuit 41, and the LED drive circuit 500 (hereinafter referred to as “intermediate-side drive circuits”) respectively.

Based on the luminance information included in the intermediate image signal SG2, the intermediate image control circuit 12 generates a control signal for controlling scanning lines 40A provided on an intermediate panel 42 and a control signal for controlling video lines 41A provided on the intermediate panel 42. Based on the color information included in the intermediate image signal SG2, the intermediate image control circuit 12 generates a control signal for driving the LED drive circuit 500. Each of the control signals generated by the intermediate image control circuit 12 includes a timing signal (that is, a synchronization signal) by which the scanning line drive circuits 40, the video line drive circuits 41, and the LED drive circuits 500 can be driven in synchronization with each other. The intermediate image control circuit 12 outputs the generated control signals to the intermediate-side drive circuits.

The control signal for controlling the scanning lines 40A is generated including information on a voltage value to be applied to the scanning lines 40A. The control signal for controlling the video lines 41A is generated including information on a voltage value to be applied to the video lines 41A. The control signal for driving the LED drive circuit 500 is generated including information on LEDs to be turned on.

Based on the input rear image signal SG3, the rear image control circuit 13 generates control signals for controlling the scanning line drive circuit 60, the video line drive circuit 61, and the LED drive circuit 700 (hereinafter referred to as “rear-side drive circuits”) respectively.

Based on the luminance information included in the rear image signal SG3, the rear image control circuit 13 generates a control signal for controlling scanning lines 60A provided on a rear panel 62 and a control signal for controlling video lines 61A provided on the rear panel 62. Based on the color information included in the rear image signal SG3, the rear image control circuit 13 generates a control signal for driving the LED drive circuit 700. Each of the control signals generated by the rear image control circuit 13 includes a timing signal (that is, a synchronization signal) by which the scanning line drive circuits 60, the video line drive circuits 61, and the LED drive circuits 700 can be driven in synchronization with each other. The rear image control circuit 13 outputs the generated control signals to the rear-side drive circuits.

The control signal for controlling the scanning lines 60A is generated including information on a voltage value to be applied to the scanning lines 60A. The control signal for controlling the video lines 61A is generated including information on a voltage value to be applied to the video lines 61A. The control signal for driving the LED drive circuit 700 is generated including information on LEDs to be turned on.

Here, the voltage value to be applied to the scanning lines and the video lines provided in each liquid crystal display will be described. When all of the liquid crystal displays are to display sub display images having the same luminance, in voltage values applied to the scanning lines and the video lines provided in the liquid crystal displays, a voltage value applied to the scanning lines and the video lines of the front display 200 is the smallest, and a voltage value applied to the scanning lines and the video lines of the rear display 600 is the largest. That is, the smallest voltage is applied to the liquid crystal display disposed at a position (a foremost surface) closest to a viewer side, and the largest voltage is applied to the liquid crystal display disposed at a position (a rearmost surface) farthest from the viewer. Accordingly, when displaying sub display images having the same luminance on the liquid crystal displays, a display device can perform adjustment such that a difference between luminance of the sub display image displayed by the front display 200, luminance of the sub display image displayed by the intermediate display 400 and passed through the front display 200, and luminance of the sub display image displayed by the rear display 600 and passed through the front display 200 and the intermediate display 400 is small.

The voltage values applied to the liquid crystal displays described above may be set to values obtained by multiplying a predetermined magnification (coefficient) based on transmittances of one or more liquid crystal displays arranged at a front surface side. The voltage value applied to the scanning lines 40A and the video lines 41A provided in the intermediate display 400 may be set to 1.2 times the voltage value indicated by the luminance information included in the front image signal SG1 (that is, the voltage value applied to the scanning lines 20A and the video lines 21A provided in the front display 200) based on a transmittance of the front display 200, for example. Further, the voltage value applied to the scanning lines 60A and the video lines 61A provided in the rear display 600 may be set to 1.5 times the voltage value indicated by the luminance information included in the front image signal SG1 (that is, for example, the voltage value applied to the scanning lines 20A and the video lines 21A provided in the front display 200) based on the transmittance of the front display 200 and a transmittance of the intermediate display 400.

Further, the control signal for driving each of the LED drive circuits 300, 500, and 700 includes order information of colors of LEDs to be caused to emit light. The order information of color is generated so as to indicate an order of different colors for each LED drive control circuit. For example, in a case where the color information included in each of the front image signal SG1, the intermediate image signal SG2, and the rear image signal SG3 is a red LED, a green LED, and a blue LED (that is, a white display image is to be displayed), each of the front image control circuit 11, the intermediate image control circuit 12, and the rear image control circuit 13 generates a control signal for turning on each of the red LED, the green LED, and the blue LED once in one frame. Specifically, in the control circuit board 100, the front image control circuit 11, the intermediate image control circuit 12, and the rear image control circuit 13 generate control signals including order information of colors, such as “red LED, green LED, and blue LED” by the front image control circuit 11, “green LED, blue LED, and red LED” by the intermediate image control circuit 12, and “blue LED, red LED, and green LED” by the rear image control circuit 13, such that LEDs of different colors are turned on by the liquid crystal displays correspondingly and a color obtained after superimposition of these colors is white.

The memory (not illustrated) includes, for example, a random access memory (RAM) as a work memory used when executing various types of processing of the control circuit board 100, and a read only memory (ROM) that stores data and a program defining operations of the control circuit board 100. Data or information generated or acquired by the control circuit board 100 is temporarily stored in the RAM. A program defining operations of the control circuit board 100 is written in the ROM.

The front display 200 is, for example, a transparent display including polymer dispersed liquid crystal (PDLC) or the like, or a transmissive display having a predetermined transmittance. The front display 200 displays a sub display image (color) by light emission of LEDs of a plurality of colors arranged at a lateral side. The front display 200 includes the scanning line drive circuit 20, the video line drive circuit 21, and the front panel 22.

The scanning line drive circuit 20 applies a predetermined voltage to each of the scanning lines 20A based on information on an application voltage value that is included in the control signal output from the front image control circuit 11 and that is to be applied to each of the scanning lines 20A.

The video line drive circuit 21 applies a predetermined voltage to each of the video lines 21A based on information of an application voltage value that is included in the control signal output from the front image control circuit 11 and that is to be applied to each of the video lines 21A.

Here, the PDLC provided in the front panel 22, the intermediate panel 42, and the rear panel 62 will be described. In the PDLC provided in the front panel 22, an alignment direction of liquid crystal molecules is reset (refreshed) or changed by the front image control circuit 11. In the PDLC provided in the intermediate panel 42, an alignment direction of the liquid crystal molecules is reset (refreshed) or changed by the intermediate image control circuit 12. In the PDLC provided in the rear panel 62, an alignment direction of the liquid crystal molecules is reset (refreshed) or changed by the rear image control circuit 13. The PDLC has a structure in which a layer in which a liquid crystal material is dispersed in a transparent polymer material is sandwiched between two sheets of glass arranged in a manner of facing each other. The liquid crystal material contains liquid crystal molecules having electro-optical characteristics, and an alignment direction of the liquid crystal molecules changes due to application of a voltage.

The front panel 22 includes the PDLC between each of the plurality of scanning lines 20A and each of the plurality of video lines 21A. In the front panel 22, when a voltage is applied to a predetermined scanning line 20A by the scanning line drive circuit 20 and a predetermined video line 21A by the video line drive circuit 21 (that is, to a predetermined pixel), the alignment direction of the liquid crystal molecules of the PDLC in a region corresponding to the predetermined pixel changes according to the magnitude of the applied voltage, and as a result, a refractive index of the liquid crystal molecules of the PDLC in the region corresponding to the predetermined pixel changes. Accordingly, in the front display 200, a state of the front panel 22 can be freely controlled from a scattering state to a transparent state according to a relationship between the refractive index of the liquid crystal molecules of the PDLC and a refractive index of the polymer material. As the applied voltage increases, a difference between the refractive index of the liquid crystal molecules of the PDLC and the refractive index of the polymer material increases, light incident from the light source 30 is scattered at an interface between the liquid crystal molecules and the polymer material, and the luminance of the sub display image (color) displayed by the front panel 22 increases. In the following description, a change in a path of the light incident from the light source 30 accompanying the change in the refractive index of the liquid crystal molecules of the PDLC provided in the front display 200 will be described, and since the change in the path of light incident from the light source accompanying the change in the refractive index of the liquid crystal molecules of the PDLC provided in the intermediate display 400 and the rear display 600 is the same, a description thereof will be omitted.

When no voltage is applied and the difference between the refractive index of the liquid crystal molecules and the refractive index of the polymer material is small, the light incident from the light source 30 transmits through the interface between the liquid crystal molecules and the polymer material without being scattered thereat, and passes between each of the plurality of scanning lines 20A and each of the plurality of video lines 21A while being totally reflected by surfaces of the two sheets of glass arranged so as to sandwich the PDLC like an optical fiber, for example. Therefore, when no voltage is applied, the light incident from the light source 30 is not diffused to the outside of the front panel 22. That is, the front panel 22 does not display a sub display image (color) in a region corresponding to a pixel to which no voltage is applied in the front panel 22.

In addition, in the front panel 22, when a voltage is applied to a predetermined pixel, the alignment direction of the liquid crystal molecules changes, and the difference between the refractive index of the liquid crystal molecules and the refractive index of the polymer material is increased. When the difference between the refractive index of the liquid crystal molecules and the refractive index of the polymer material is large, the light incident from the light source 30 is scattered at the interface between the liquid crystal molecules and the polymer material, and is scattered toward the outside of the front panel 22. Accordingly, when a voltage is applied, the front panel 22 can diffuse light of LEDs toward the outside only in the predetermined pixel to which the voltage is applied, and can display a sub display image (color).

The LED drive circuit 300 executes control of turning on or turning off LEDs of a predetermined color, based on the color information included in the control signal output from the front image control circuit 11.

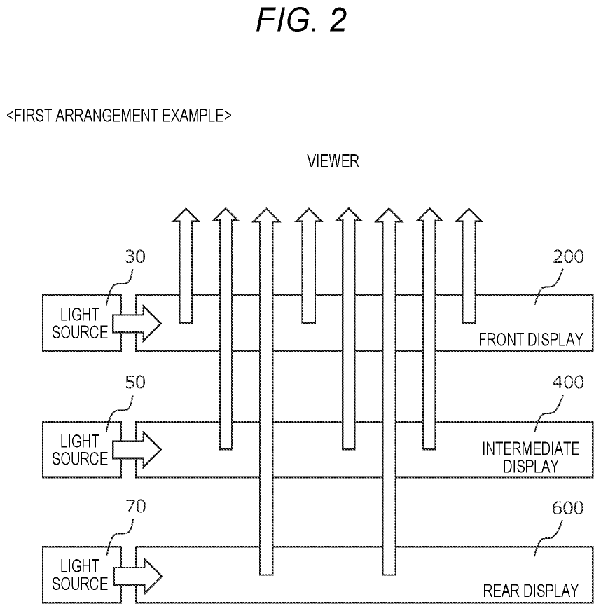

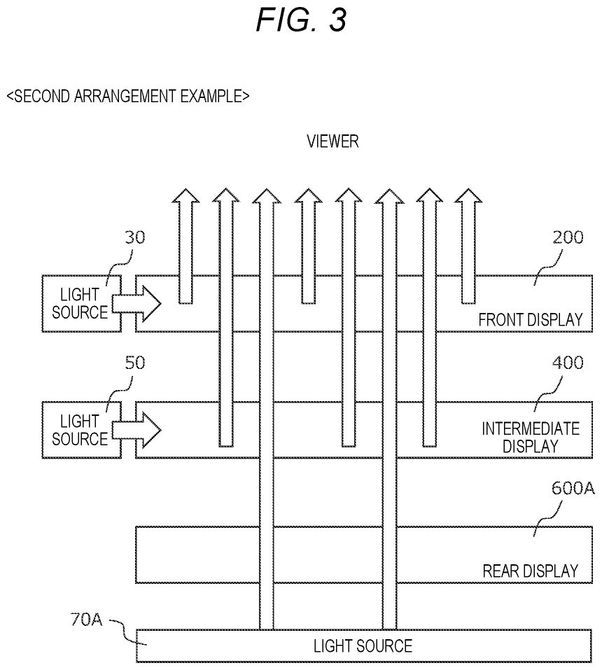

For example, the light source 30 is capable of emitting light of a plurality of colors of a red LED 30R, a green LED 30G, and a blue LED 30B, and is provided at a lateral side of the front panel 22 (see FIGS. 2 and 3). The light source 30 is controlled by the LED drive circuit 300 to turn on or turn off LEDs of a predetermined color. The light source 30 illustrated in FIG. 1 includes LEDs of three colors, and may alternatively include LEDs of two colors or four or more colors. In the case of two colors, the light source 30 includes LEDs of two colors among a red LED, a green LED, and a blue LED, and in the case of four colors, the light source 30 includes a red LED, a green LED, a blue LED, and a magenta LED or a yellow LED.

The intermediate display 400 is, for example, a transparent display including the PDLC or the like, or a transmissive display having a predetermined transmittance. The intermediate display 400 displays a sub display image (color) by light emission of LEDs of a plurality of colors arranged at a lateral side. The intermediate display 400 includes the scanning line drive circuit 40, the video line drive circuit 41, and the intermediate panel 42.

The scanning line drive circuit 40 applies a predetermined voltage to each of the scanning lines 40A based on information on an application voltage value that is included in the control signal output from the intermediate image control circuit 12 and that is to be applied to each of the scanning lines 40A.

The video line drive circuit 41 applies a predetermined voltage to each of the video lines 41A based on information on an application voltage value that is included in the control signal output from the intermediate image control circuit 12 and that is to be applied to each of the video lines 41A.

The intermediate panel 42 includes the PDLC between each of the plurality of scanning lines 40A and each of the plurality of video lines 41A. In the intermediate panel 42, when a voltage is applied to a predetermined scanning line 40A by the scanning line drive circuit 40 and a predetermined video line 41A by the video line drive circuit 41 (that is, to a predetermined pixel), the alignment direction of the liquid crystal molecules of the PDLC in a region corresponding to the predetermined pixel changes based on the magnitude of the applied voltage, and as a result, a refractive index of the liquid crystal molecules of the PDLC in the region corresponding to the predetermined pixel changes. Accordingly, in the intermediate display 400, a state of the intermediate panel 42 can be freely controlled from a scattering state to a transparent state according to the relationship between the refractive index of the liquid crystal molecules of the PDLC and the refractive index of the polymer material.

The LED drive circuit 500 executes control of turning on or turning off LEDs of a predetermined color, based on the color information included in the control signal output from the intermediate image control circuit 12.

For example, the light source 50 is capable of emitting light of a plurality of colors of a red LED 50R, a green LED 50G, and a blue LED 50B, and is provided at a lateral side of the intermediate panel 42 (see FIGS. 2 and 3). The light source 50 is controlled by the LED drive circuit 500 to turn on or turn off LEDs of a predetermined color. Further, the light source 50 illustrated in FIG. 1 includes LEDs of three colors, and may alternatively include LEDs of two colors or four or more colors. In the case of two colors, the light source 50 includes LEDs of two colors among a red LED, a green LED, and a blue LED, and in the case of four colors, the light source 50 includes a red LED, a green LED, a blue LED, and a magenta LED or a yellow LED.

The rear display 600 is, for example, a transparent display including PDLC or the like, or a transmissive display having a predetermined transmittance. The rear display 600 displays a sub display image (color) by light emission of LEDs of a plurality of colors arranged at a lateral side. The rear display 600 includes the scanning line drive circuit 60, the video line drive circuit 61, and the rear panel 62.

The scanning line drive circuit 60 applies a predetermined voltage to each of the scanning lines 60A based on information on an application voltage value that is included in the control signal output from the rear image control circuit 13 and that is to be applied to each of the scanning lines 60A.

The video line drive circuit 61 applies a predetermined voltage to each of the video lines 61A based on information on an application voltage value that is included in the control signal output from the rear image control circuit 13 and that is to be applied to each of the video lines 61A.

The rear panel 62 includes the PDLC between each of the plurality of scanning lines 60A and each of the plurality of video lines 61A. In the rear panel 62, when a voltage is applied to a predetermined scanning line 60A by the scanning line drive circuit 60 and a predetermined video line 61A by the video line drive circuit 61 (that is, to a predetermined pixel), the alignment direction of the liquid crystal molecules of the PDLC in a region corresponding to the predetermined pixel changes according to the magnitude of the applied voltage, and as a result, a refractive index of the liquid crystal molecules of the PDLC in the region corresponding to the predetermined pixel changes. Accordingly, in the rear display 600, a state of the rear panel 62 can be freely controlled from a scattering state to a transparent state according to the relationship between the refractive index of the liquid crystal molecules of the PDLC and the refractive index of the polymer material.

The LED drive circuit 700 executes control of turning on or turning off LEDs of a predetermined color, based on the color information included in the control signal output from the rear image control circuit 13.

For example, the light source 70 is capable of emitting light of a plurality of colors of a red LED 70R, a green LED 70G, and a blue LED 70B, and is provided at a lateral side of the rear panel 62 (see FIG. 2). The light source 70 is controlled by the LED drive circuit 700 to turn on or turn off LEDs of a predetermined color. Further, the light source 70 illustrated in FIG. 1 includes LEDs of three colors, and may alternatively include LEDs of two colors or four or more colors. In the case of two colors, the light source 70 includes LEDs of two colors among a red LED, a green LED, and a blue LED, and in the case of four colors, the light source 70 includes a red LED, a green LED, a blue LED, and a magenta LED or a yellow LED.

The rear display 600 illustrated in FIG. 1 may be a liquid crystal display in the related art that does not transmit light or has a low transmittance. A configuration of such a rear display will be described with reference to a second arrangement example illustrated in FIG. 2.

Arrangement examples of the light sources 30, 50 and 70 will be described with reference to FIGS. 2 and 3. FIG. 2 is a diagram illustrating a first arrangement example of the light sources 30, 50 and 70 according to the embodiment. FIG. 3 is a diagram illustrating the second arrangement example of light sources 30, 50 and 70A according to the embodiment.

The front display 200, the intermediate display 400, and the rear display 600 in the first arrangement example are a transmissive display including the PDLC or a transparent display. In such a case, the light source 30 is provided at a lateral side of the front display 200. The light source 50 is provided at a lateral side of the intermediate display 400. The light source 70 is provided at a lateral side of the rear display 600.

In the front display 200, the intermediate display 400, and the rear display 600 in the first arrangement example, when a voltage is applied to a predetermined pixel by the scanning line drive circuits 20, 40 and 60 and the video line drive circuits 21, 41 and 61, light scattered by each of the front display 200, the intermediate display 400, and the rear display 600 enters the eyes of a viewer as a plurality of sub display images. At this time, the sub display images (colors) displayed by the front display 200, the sub display images (colors) displayed by the intermediate display 400, and the sub display images (colors) displayed by the rear display 600 are superimposed and look like one single display image (stereoscopic image) to the viewer.

The front display 200 and the intermediate display 400 in the second arrangement example are a transmissive display including the PDLC or a transparent display. On the other hand, the rear display 600A is a liquid crystal display in the related art that does not transmit light or has a low transmittance, and includes a light source 70A at a rear surface (a side opposite to a side where the viewer is present) of the rear display 600A.

In the front display 200 of the second arrangement example, when a voltage is applied to a predetermined pixel through the scanning line and the video line, the liquid crystal molecules of the PDLC are aligned in an electric field direction, and light of a predetermined color incident from the light source 30 is reflected in the electric field direction (the direction toward the viewer) and in a direction opposite to the electric field direction.

The rear display 600A in the second arrangement example includes the light source 70A at the rear surface. Here, the light source 70A includes LEDs of a plurality of different colors. The light source 70A is controlled by the LED drive circuit 700. also, in the display device including three or more liquid crystal displays, two liquid crystal displays disposed at a front surface and the middle are implemented by a transmissive display including the PDLC or a transparent display, for example, and a liquid crystal display disposed at a rear surface is implemented by an FSC liquid crystal display in the related art that does not transmit light or has a low transmittance.

Each of the sub display images (colors) displayed by the front display 200, the intermediate display 400, and the rear display 600A in the second arrangement example enters the eyes of the viewer as a plurality of sub display images. At this time, the sub display images (colors) displayed by the front display 200, the sub display images (colors) displayed by the intermediate display 400, and the sub display images (colors) displayed by the rear display 600A are superimposed and look like one single display image (stereoscopic image) to the viewer.

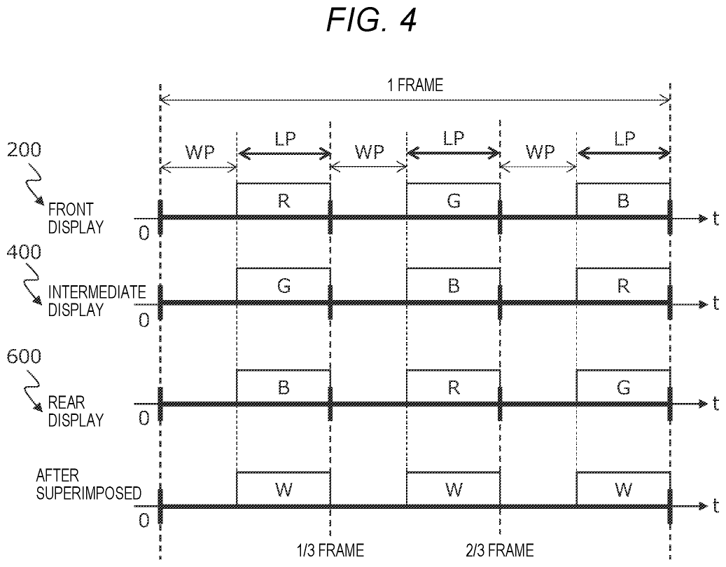

Next, a control example of various drive circuits for reducing color breakup by a display device including three liquid crystal displays will be described with reference to FIG. 4. FIG. 4 is a diagram illustrating a drive control example of the display device. FIG. 4 illustrates an example in which the display device performs control to display a white display image (stereoscopic image).

An example is illustrated in which each of the plurality of liquid crystal displays provided in the display device according to the embodiment illustrated in FIG. 4 has a refresh rate of 180 Hz. The number of sub display images displayed by the liquid crystal display for which the refresh rate is set to 180 Hz is three per frame. The sub-frame has a length of ⅓ of one frame.

In the front display 200, the scanning line drive circuit 20, the video line drive circuit 21, and the LED drive circuit 300 are driven such that the refresh rate is 180 Hz.

In the intermediate display 400, the scanning line drive circuit 40, the video line drive circuit 41, and the LED drive circuit 500 are driven such that the refresh rate is 180 Hz.

In the rear display 600, the scanning line drive circuit 60, the video line drive circuit 61, and the LED drive circuit 700 are driven such that the refresh rate is 180 Hz.

The front display 200, the intermediate display 400, and the rear display 600 illustrated in FIG. 4 simultaneously turn on LEDs, each turning on an LED of one different color for each sub-frame. In the front display 200, the intermediate display 400, and the rear display 600, control of applying a predetermined voltage to a predetermined pixel during a writing time WP to adjust the refractive index of the liquid crystal molecules of the PDLC, and scattering light of an LED of a predetermined color to a viewer side during a turning-on time LP to display a sub display image is repeatedly executed for sub-frames.

The display device including three liquid crystal displays displays, toward the viewer, a display image (color) obtained after sub display images (colors) displayed on the front display 200, the intermediate display 400 and the rear display 600 respectively are superimposed. Accordingly, the display device illustrated in FIG. 4 can display a sub display image of a different color on each of the plurality of liquid crystal displays. That is, the display device displays different colors corresponding to the number of light sources, so that the color (display image) of the superimposed one color is more likely to be visually recognized by the visual sense of the viewer, instead of the colors (sub display images) displayed by the liquid crystal displays respectively. Accordingly, the display device can reduce a change in color between the sub-frames in the same frame, and can switch the display image (stereoscopic image) so that the viewer is less likely to visually recognize the color breakup.

As described above, the display device according to the embodiment can switch colors of sub display images displayed by n liquid crystal displays so that the viewer is less likely to visually recognize the color breakup.

Although control in a case where a white display image is displayed has been described as an example in the present embodiment, the present invention is not limited thereto. For example, when displaying a yellow display image, the display device may control the red LED and the green LED as described above.

As described above, the display device according to the embodiment can display a display image obtained by superimposing a plurality of sub display images. The display device includes n (n being an integer equal to or greater than 2) number of liquid crystal displays (for example, the front display 200, the intermediate display 400, and the rear display 600 illustrated in FIG. 1) that display a plurality of sub display images, the light sources 30, 50, 70, and 70A that are provided individually for each liquid crystal display and are capable of emitting light of m (m being an integer equal to or greater than 2) number of different colors, and the control circuit board 100 that causes each of the light sources 30, 50, 70, and 70A corresponding to the liquid crystal displays to emit light of different colors based on an input signal including color information on the sub display image to be displayed on each liquid crystal display. For example, when the color information indicates white, the control circuit board 100 causes the light source 30 to turn on the red LED 30R, causes the light source 50 to turn on the green LED 50G, and causes the light source 70 to turn on the blue LED 70B so that a color of light obtained by superposing the light of the light sources is white. The number n of liquid crystal displays is an integral multiple of the number m of colors of light that can be emitted by the light sources 30, 50, 70, and 70A.

Therefore, the display device according to the embodiment can simultaneously display display images (colors) corresponding to the number m of colors of light that can be emitted by the light sources 30, 50, 70, and 70A on the respective liquid crystal displays. That is, since the display device turns on light of different colors (that is, displays display images) simultaneously in the plurality of liquid crystal displays, the color (display image) of the superimposed one color is more likely to be visually recognized by the visual sense of the viewer, instead of the colors (sub display images) displayed by the liquid crystal displays respectively. Accordingly, the display device can reduce a change in color between the sub-frames in the same frame, and can switch the display image (stereoscopic image) so that the viewer is less likely to visually recognize the color breakup.

As described above, the control circuit board 100 in the display device according to the embodiment generates, for each light source, order information of a color of light emitted in each of a plurality of sub-frames obtained by dividing one frame of a sub display image in accordance with the number of light that can be emitted by the light source corresponding to a liquid crystal display, based on the color information corresponding to the liquid crystal display, and individually causes the light source to emit light based on the order information. Accordingly, with the display device according to the embodiment, it is less likely for the viewer to visually recognize, with his/her eyes, the switching of the display image (color) for each sub-frame of each liquid crystal display by the order information of a color of light emitted in each of a plurality of sub-frames, and thus it is possible to prevent the color breakup.

As described above, among the plurality of liquid crystal displays provided in the display device according to the embodiment, a first liquid crystal display (for example, the front display 200 illustrated in FIGS. 1 to 3) disposed at a foremost surface on the viewer side is a transparent display. Accordingly, the display device according to the embodiment can transmit and scatter, toward the viewer, sub display images (colors) of the light sources 50, 70, and 70A of other liquid crystal displays arranged at a rear surface side of the first liquid crystal display (in a direction away from the viewer), and display a display image (stereoscopic image) obtained by superimposing the sub display images of the n number of liquid crystal displays.

As described above, the control circuit board 100 in the display device according to the embodiment controls an applied voltage so that a voltage applied to the liquid crystal display disposed at the rear surface side is larger than a voltage applied to the liquid crystal display disposed at a front surface side (viewer side). Accordingly, the display device according to the embodiment can adjust a difference between luminance of a sub display image of the liquid crystal display disposed at the foremost surface and luminance of a sub display image of the liquid crystal display disposed at a rearmost surface to be small while preventing a decrease in luminance of a sub display image displayed by the liquid crystal display disposed at the rear surface side.

As described above, the light source 30 corresponding to the first liquid crystal display (for example, the front display 200 illustrated in FIGS. 1 to 3) according to the embodiment is disposed at a side surface side of the first liquid crystal display. Accordingly, the display device according to the embodiment can transmit and display, toward the viewer, the light (display image) of the light sources 50, 70, and 70A of the liquid crystal displays disposed at the rear surface side, and can display a display image (stereoscopic image) obtained by superimposing the sub display images of then number of liquid crystal displays.

Although various embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, the components in the embodiments described above may be freely combined without departing from the gist of the invention.

The present application is based on Japanese Patent Application No. 2020-116580 filed on Jul. 6, 2020, and the contents thereof are incorporated herein by reference.

### Industrial Applicability

The present disclosure is useful as a display device and a display method capable of preventing color breakup of a display image displayed using a field sequential color system.

What is claimed is:

1. A display device capable of displaying a display image obtained by superimposing a plurality of sub display images, the display device comprising:
n number of liquid crystal displays, where n is an integer equal to or greater than 2, that display the plurality of sub display images;
a light source that is provided for each liquid crystal display and is capable of emitting light of m number of different colors, where m is an integer equal to or greater than 2; and
a processor that causes the light source corresponding to the liquid crystal display to emit light of a different color based on an input signal including color information on the display image displayed by each liquid crystal display,
wherein the number n of the liquid crystal display is an integral multiple of the number m of color of light that the light source is capable of emitting.

2. The display device according to claim 1,
wherein the processor generates, for each light source, order information of a color of light to be emitted in each of a plurality of sub-frames obtained by dividing one frame of the display image according to the number of colors of light that is able to be emitted by the light source corresponding to the liquid crystal display, based on the color information corresponding to the liquid crystal display, and individually causes the light source to emit light based on the order information.

3. The display device according to claim 1,
wherein a first liquid crystal display disposed at a foremost surface on a viewer side among the plurality of liquid crystal displays is a transparent display

4. The display device according to claim 1,
wherein the processor controls an applied voltage so that a voltage applied to the liquid crystal display disposed at a rear surface side is larger than a voltage applied to the liquid crystal display disposed at a front surface side.

5. The display device according to claim 3,
wherein the light source corresponding to the first liquid crystal display is disposed at a side surface of the first liquid crystal display.

6. The display device according to claim 1,
wherein in a case that the liquid crystal display disposed at a foremost surface on a viewer side among the plurality of liquid crystal displays is set as a first liquid crystal display, the light source corresponding to an n-th liquid crystal display disposed at a rearmost surface farthest from the first liquid crystal display is disposed at a rear surface side of the n-th liquid crystal display.

7. A display method capable of displaying a display image obtained by superimposing a plurality of sub display images, the display method comprising:
acquiring an input signal including color information of the sub display images to be displayed individually by n number of liquid crystal displays, where n is an integer equal to or greater than 2; and
causing a light source, which is provided for each liquid crystal display and is capable of emitting light of m number of different colors, where m is an integer equal to or greater than 2, to emit light of different colors based on the color information,
wherein the number n of the liquid crystal display is an integral multiple of the number m of color of light that the light source is capable of emitting.
